(19) United States
(12) Patent Application Publication
(10) Pub. No.: US 2024/0207938 A1
(43) Pub. Date: Jun. 27, 2024

(54) ADDITIVE MANUFACTURING OF COMPLEX METAL STRUCTURES

(71) Applicant: Tokamak Energy Ltd, Abingdon Oxfordshire (GB)

(72) Inventor: Alasdair Morrison, Thame, Oxfordshire (GB)

(21) Appl. No.: 18/555,641

(22) PCT Filed: Apr. 8, 2022
(86) PCT No.: PCT/EP2022/059477

§ 371 Date: Oct. 16, 2023

(30) Foreign Application Priority Data
Apr. 15, 2021 (GB) 2105385.5
Feb. 28, 2022 (WO) PCT/EP2022/054990

(51) Int. Cl. B22F 10/28; B22F 3/105; B22F 7/04; B22F 7/06; B22F 12/41; B33Y 10/00; B33Y 80/00

(52) U.S. Cl. CPC B22F 10/28; B22F 7/04; B22F 7/064; B22F 12/41; B22F 2003/1051; B22F 2007/045; B22F 2998/10; B33Y 10/00; B33Y 80/00

(57) ABSTRACT

A method of manufacturing an interlayer comprising a first material and a second material. A first structure (302) is formed from the first material on a first surface using an additive manufacturing technique. The first structure comprises at least one surface which is not in contact with the first surface and faces towards the first surface at an angle of less than 90 degrees. A second structure (303) is formed from the second material, such that the second structure conforms to the first structure on a side of the first structure opposite the first surface. The first structure and the second structure together form the interlayer, and the first structure and second structure are shaped such that separating the first and second structure requires deforming one or both of the first or second structure.

### FIELD OF THE INVENTION

The present invention relates to an interlayer for joining materials of dissimilar coefficient of thermal expansion (CTE).

### BACKGROUND

A divertor is a device within a tokamak plasma vessel which allows for removal of waste material and power from the plasma while the tokamak is operating. The waste material naturally arises as particles diffuse out from the magnetically confined plasma core. To confine the plasma, tokamaks utilise magnetic fields. However, particles slowly and randomly diffuse out, and eventually impact one of the divertor surfaces, which are configured to withstand the high flux of ions.

FIG. 1 shows a cross section of a tokamak plasma chamber, illustrating one possible configuration of the divertor. The divertor surfaces 101 are at the top and bottom of the plasma chamber 100. The plasma chamber first wall (i.e. plasma facing components) includes the inner wall 102 of the chamber, and also includes baffles 103 located close to each divertor surface, for directing the plasma at the divertors, and covers 104 over field coils internal to the plasma chamber.

The high heat flux and erosion experienced by the surface layer of a divertor requires a material that can stand up to those conditions. A common choice is a refractory metal having a melting point over 1850° C., e.g. titanium or vanadium, more preferably over 2000° C., e.g. molybdenum, or tungsten. However, refractory metals are generally brittle, so the cooling elements of the divertor which contain a coolant under pressure are commonly made from an alternative material which is tougher (hereafter a “thermally conductive material”), such as copper.

This presents a problem—the thermal expansion coefficient of the thermally conductive material will be very different to that of the refractory metal, and there will be significant heat flux and temperature changes at the join between them. This means that a common failure mode of a divertor is damage due to stresses at this join.

The stresses at the join between the thermally conductive material and the refractory metal can be mitigated by providing an interlayer—a layer of material having a thermal expansion coefficient intermediate between that of the refractory metal and that of the thermally conductive material. The interlayer may be a composite material comprising both the refractory metal and the thermally conductive material, and may be graded such that the proportion of each material varies linearly through the interlayer, to provide a more gradual change in thermal expansion coefficient and other material mechanical and thermal properties.

FIG. 2 shows the grading profile of exemplary known interlayers. Each interlayer 201 joins a high thermal expansion material 202 to a low thermal expansion material 203. In the example of a divertor for a tokamak, the high thermal expansion material may be copper and the low thermal expansion material may be tungsten. The interlayer depth “d” is the distance across the interlayer from the high thermal expansion material to the low thermal expansion material. Within this disclosure, the depth d will be measured in arbitrary units such that the transition between the high thermal expansion material 202 and the interlayer 201 is at d=0, and the transition between the low thermal expansion material 203 and the interlayer 201 is at d=1. It will be appreciated that any description relying on this definition of d can be transformed into any other scale for measuring the distance d by suitable mathematical operations, and this definition does not limit the thickness of the interlayer to 1 of any particular unit.

The “linear” interlayer 210 has a thermal expansion coefficient which decreases linearly with distance across the interlayer. While this is shown as a continuous decrease, it may be the result of e.g. a laminated composite with differing proportions of high thermal expansion and low thermal expansion layers in the different regions, with the value plotted on the graph being the effective bulk thermal expansion coefficient over a small distance.

The “stepped” interlayer 220 has a thermal expansion coefficient which decreases in a stepwise fashion with distance across the interlayer, with a linear decrease between each step.

Each of these could be effectively implemented by lamination of thin films of each material, or by powder grading. However, lamination results in bonding layers through the interlayer which are parallel to it, and may be prone to failure depending on the materials being joined. Powder grading can suffer from similar failures in stepwise interlayers, at the interface between layers of different grading.

While the above has been written in the context of a divertor for a tokamak, such interlayers are also useful in other contexts where there is a need to join two materials with different thermal expansion coefficients where temperature variations occur. The particular case of a refractory metal joined to a thermally conductive material is also relevant on the “first wall” (i.e. plasma facing surface) of a plasma chamber such as a tokamak, and to other applications where a high heat flux and high erosion are expected, such as rocket exhausts.

### SUMMARY

According to a first aspect of the invention, there is provided a method of manufacturing an interlayer comprising a first material and a second material. A first structure 302 is formed from the first material on a first surface using an additive manufacturing technique. The first structure comprises at least one surface which is not in contact with the first surface and faces towards the first surface at an angle of less than 90 degrees.

A second structure 303 is formed from the second material, such that the second structure conforms to the first structure on a side of the first structure opposite the first surface. The first structure and the second structure together form the interlayer, and the first structure and second structure are shaped such that separating the first and second structure requires deforming one or both of the first or second structure.

According to a second aspect, there is provided an interlayer for joining first and second components. The interlayer comprises first and second surfaces and first and second structures. The first structure is formed from a first material, and extends from the first surface. The first structure has at least one surface which is not in contact with the first surface and faces towards the first surface at an angle of less than 90 degrees. The second structure is formed from a second material. The second structure extends to the second surface and conforms to the first structure on a side of the first structure opposite the first surface. The first structure and the second structure together form the interlayer, and the first structure and second structure are shaped such that separating the first and second structure requires deforming one or both of the first or second structure.

Further embodiments are provided in claim 2 et seq.

### BRIEF DESCRIPTION OF THE DRAWINGS

FIG. 1 is a cross section of a tokamak plasma chamber;

FIG. 2 shows the grading profile of exemplary known interlayers;

FIG. 3 illustrates the steps of manufacture of an interlayer;

FIGS. 4A and 4B are cross sections of an exemplary interlayer structure;

FIGS. 5A to 5C show “first structures” for interlayers according to various TPMS based constructions;

FIG. 6 illustrates the grading profile of two proposed interlayers;

FIG. 7 shows an abstraction of the grading profiles of FIG. 6.

### DETAILED DESCRIPTION

A construction for producing a composite interlayer is illustrated in FIG. 3. In step 310 a surface 301 is provided on which the interlayer will be formed. This may be one of the surfaces to be joined by the interlayer (i.e. when manufacturing the interlayer in place), may be an initial layer of the interlayer, or may be a “printing bed” or similar surface, which is used for manufacture and then removed. In step 320, a first structure 302 formed from a first material (e.g. tungsten) is produced on the surface 301 via an additive manufacturing process (e.g. “3d printing” or other suitable processes as described below). In step 330 a second material (e.g. copper) is filled into that first structure 302 (e.g. by casting, powder sintering, or other methods as described later) to form a second structure 303 which, together with the first structure, forms the completed interlayer. The first structure extends to the first side of the interlayer (i.e. the bottom side in the figure), and the second structure extends to the second side of the interlayer (i.e. the top side).

The use of additive manufacture to form the initial structure provides several benefits. Firstly, additive manufacture processes will often provide a somewhat rough surface, which improves bonding to the second material. Secondly, the use of additive manufacture allows for complex shapes to be formed at small scale. This potential complexity allows for a larger surface area of interface between the two materials for a given area of the interlayer, and for additional features to provide mechanical keying between the two materials. Furthermore, such structures can be easily designed with “structural grading” i.e. the configuration of the first structure such that the resulting layer has a given relationship between depth and proportion of each material.

Mechanical keying is provided by including features such that, even in the case of complete failure of the bonding between them, the first and second structures could not be pulled apart without deforming one or both of them. For example, this may be achieved by having “overhangs” in the first structure as shown in FIG. 4A, which shows some example overhanging structures 401, 402, 403. In this figure, each overhanging structure has a part 410 where the surface of the first structure faces down towards the 10 first side of the interlayer (i.e. towards the component the first material of the interlayer is attached to, or the initial build surface). This may be any generally downward facing surface—i.e. at an angle of less than 90 degrees to the bulk of the first material, more preferably less than 45 degrees, more preferably less than 30 degrees, more preferably less than 10 degrees, more preferably directly downward facing. The downward facing surface may be part of a curved surface where the tangent plane to the surface has such an angle to the bulk of the first material. In some examples, this may include the first structure having through holes as shown in FIG. 4B, for example structures 404, 405, such that the second structure (once formed) loops through the through holes 420 and it would not be possible to separate the two structures without breaking one or both structures. As shown in the example 405, this includes the case where one surface of the through hole is the surface 301—i.e. the printing bed or the surface to which the interlayer is attached.

It is advantageous for the first surface to have a large surface area, when compared to the area in the plane of the interlayer. Greater surface area improves the overall bonding strength between the first structure and the second material, and inhibits the propagation of cracks across the interlayer.

To simplify design of the first structure, it may be designed as several smaller units which are tiled across the plane of the interlayer, and then the resulting tiling is printed to form the first structure. The first structure may be a periodic structure, e.g. where the tiles are the same and can tile periodically, or it may be a non-periodic structure, e.g. to provide different types of structure in different parts of the interlayer. For example, the first structure may be configured such that one region has improved keying features for additional structural stability, and another region has a different structural grading profile to account for differences in expected heat load across the interlayer.

One particularly useful class of surfaces which can be used to design the first structure are triply periodic minimal surfaces (TMPS), which are a class of mathematical surfaces which locally minimise their area, and which tile space periodically in three dimensions. Depending on the TPMS used, it can be converted from an infinitely thin mathematical ideal to a practical structure than can be printed by either filling in the surface (e.g. capping any exposed ends and filling the interior of the capped surface), or expanding the surface with a non-zero thickness (e.g. such that the structure is the locus of points within a distance t of the surface, where t may be a function of position within the interlayer and/or may be restricted to measurement in one plane).

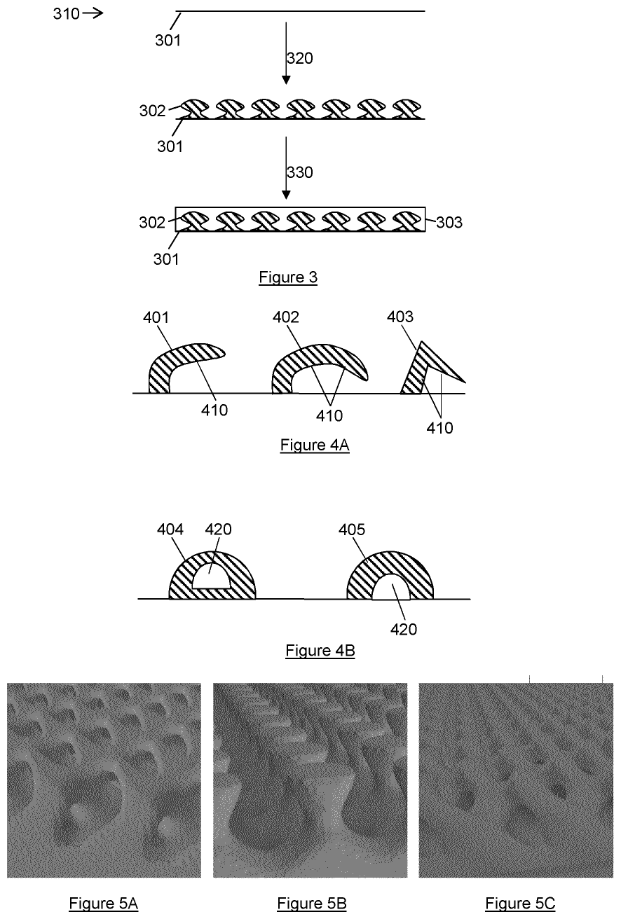

Three TMPS of note are the gyroid, SchwarzD and SchwarzP surfaces, defined by the following equations and shown in FIG. 5A to 5C:

sin x cos y+sin y cos z+sin z cos x=0 Gyroid (FIG. 5A):

sin x sin y sin z+sin x cos y cos z+cos x sin y cos z+cos x cos y sin z=0 SchwarzD (FIG. 5B):

cos x+cos y+cos z=0 SchwarzP (FIG. 5C):

Each figure shows a portion of the surface, as would be used to construct an interlayer. For the gyroid and SchwarzP surface, this involves expanding the surface with a thickness depending on the depth into the interlayer, and for the SchwarzD surface this involves capping and filling the surface as described above. In each case, the position of the surface is chosen such that the first material fills the lower portion of the interlayer. The gyroid and SchwarzP surface provide improved mechanical keying compared to the SchwarzD surface, due to the presence of through holes (i.e. it would require actual breaking of the structures to separate them, rather than just deformation), and additionally their construction allows for the thickness at different depths through the interlayer to be more easily configured, e.g. by varying the distance t as defined previously. In each case, the region of the TPMS within the bounds of the interlayer is at most one period vertically (i.e. in the direction of the thickness of the interlayer), and extends for many periods horizontally. The size of each cell (i.e. unit of the repeating structure) of the TMPS can be adjusted by applying appropriate scaling to the function defining it. 1

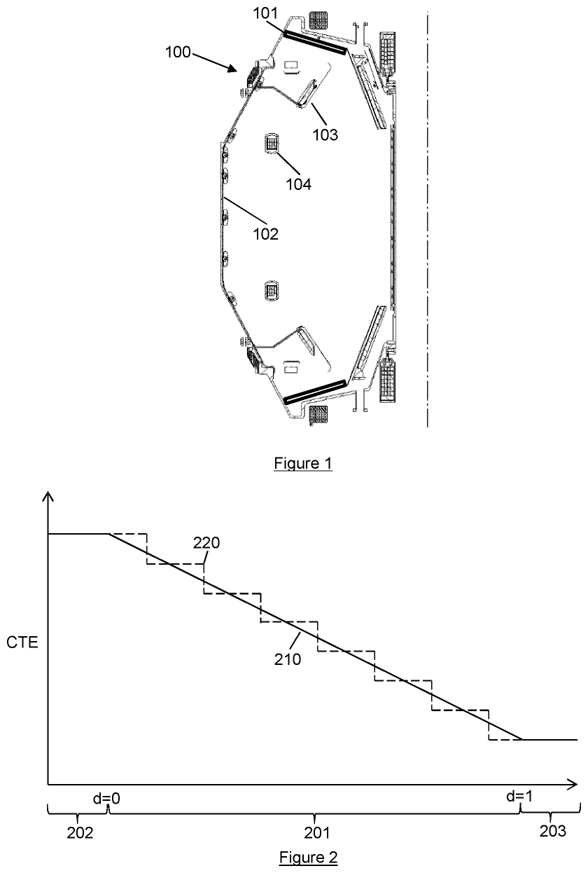

The first structure may be configured to have a specific cross section at each depth through the interlayer, e.g. as a proportion of the area of the interlayer. In this way the required grading for the interlayer can be achieved structurally. For example, to achieve the linear grading 210 shown in FIG. 2, the first structure may be configured such that the cross section of the first structure varies linearly from 100% of the area of the interlayer at the depth d=0, to 0% of the area of the interlayer at the depth d=1. As the average coefficient of thermal expansion at a given depth into the interlayer is an average of the coefficient of thermal expansion of each material, weighted by the cross section of each material at that depth, this linear variation of the cross section of the first material results in a linear variation of the coefficient of thermal expansion through the interlayer, as required. Due to the ease of making complex structures via additive manufacturing, this allows for a wide range of desired grading profiles to be obtained.

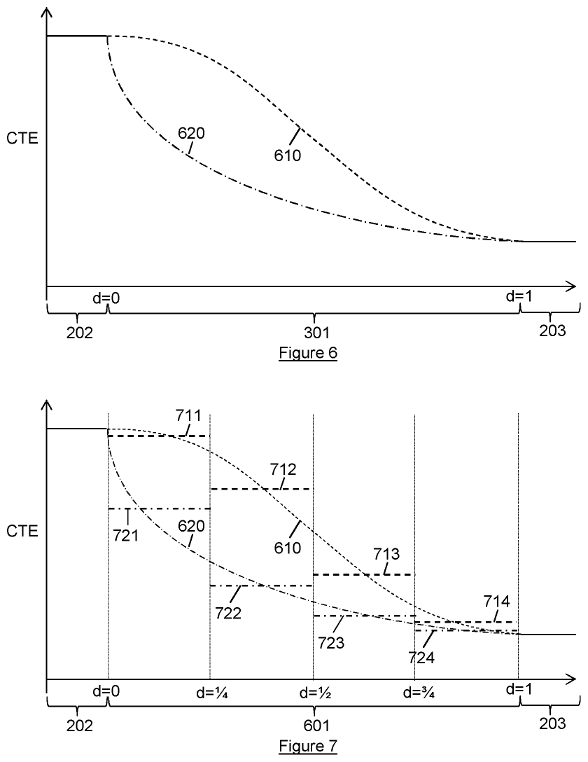

FIG. 6 shows two proposals for alternative interlayer gradings. Each interlayer 601 joins a high thermal expansion material 202 to a low thermal expansion material 203. The first exemplary interlayer is a “sigmoid” interlayer 610, which follows a sigmoid function, i.e. a function where the slope tends to zero at each of the material layers 202, 203, and which has exactly one inflection point. This low slope at the joins between the interlayer and each material ensures that these regions have only low stress when thermal expansion occurs, and that the stress is instead in the central regions of the interlayer where material bonding is likely to be stronger.

The second exemplary interlayer 620 follows a function such that the slope of the function approaches zero monotonically towards the low thermal expansion material, i.e. the magnitude of the slope is always steady or decreasing as the function moves towards the low thermal expansion material. This results in the steepest changes in thermal expansion coefficient being adjacent to the high thermal expansion material, which provides favourable performance as the high thermal expansion material and the interlayer at that interface will generally be more ductile and compliant than the low thermal expansion material and the interlayer at the corresponding interface, and therefore able to accommodate higher stresses without failure.

One example function for the second exemplary interlayer would be a polynomial function of the form α=Σₖ₌₀ⁿ aₖd^{k}, where α is the coefficient of thermal expansion (CTE) (averaged over a small thickness, in the case of composite materials), d is the depth through the interlayer (i.e. the distance from one of the materials being joined), and aₖ are numerical coefficients. By selection of the coefficients aₖ, a profile can be determined such that slope of the resulting function approaches zero monotonically at least within the range of the interlayer (0<d<1, as defined previously). For example the interlayer may follow a square function (where n=2) or a cubic function (where n=3).

While the exemplary interlayers shown in FIG. 6 are idealisations, approximations to those structures will still give considerably better results than simple linear or stepped interlayers. In the following description, “average CTE” of a region of the interlayer means the weighted average of the CTE of each material in the interlayer, weighted by the volume fraction of the material in that region.

Similar to the difference between the linear interlayer and stepped interlayer in FIG. 2, a stepped equivalent to the interlayer functions described with reference to FIG. 6 may be created. For the below discussion, consider an interlayer divided into N steps along its thickness, with each step taking up 1/N of the thickness of the interlayer, where N is at least 4 (to allow distinction over a stepped interlayer). The average CTE of each step has a value between the CTEs of the materials to be joined, and the average CTEs of each step decrease across the interlayer from the high thermal conductivity surface (connected to the material with high CTE) to the low thermal expansion surface (connected to the material with low CTE).

For an approximation to the sigmoid interlayer, the difference in average CTE for adjacent steps closer to the edge of the interlayer (i.e. closer to the high or low thermal expansion surfaces) will be less than the difference in average CTE for adjacent steps towards the midpoint of the interlayer.

For an approximation to the second exemplary interlayer, the difference in average CTE for adjacent steps will be greater the closer those steps are to the high thermal expansion surface.

While the above is described in terms of an interlayer constructed in discrete steps, it also applies to other constructions of an interlayer. As a first example, an interlayer which perfectly follows the functions shown in FIG. 6 would also have such a variation of average CTE for N regions defined along the thickness of the interlayer, as would various intermediate approximations between the exact function and the stepped interlayer.

The particular case of N=4 is shown in FIG. 7, which demonstrates this approximation for the interlayer functions 610 and 620. The interlayer is divided into 4 sections, from d=0 to d=¼, d=¼ to d=½, d=½ to d=¾, and d=¾ to d=1. The average value of each section is shown for each interlayer (711, 712, 713, 714 for the interlayer function 610, from high to low CTE, and 721, 722, 723, 724 for the interlayer function 620, from high to low CTE). As can be seen from the figure, the differences between these averages have the relationships described above.

The N=4 case will hold for any interlayer sufficiently different from the linear interlayers to show the desired improvements. The advantage will increase for interlayers that obey closer approximations to the smooth functions discussed above, but this will be a trade off with structural requirements of the interlayer (e.g. providing sufficient strength to keying features) and practicality of manufacture (e.g. there may be a need for a minimum cross section of e.g. 5%, 2%, or 1% of the interlayer area as the ideal grading function tends to zero, because the resulting structure would otherwise not be achievable).

Where the above discusses average CTE, it should be noted that this is linearly related to the fraction of the interlayer within the region which is composed of the first material. In particular,

$$aCTE = k ( {CTE}_{1} ) + ( 1 - k ) ( {CTE}_{2} ) ⇒ k = \frac{aCTE}{( {CTE}_{1} - {CTE}_{2} )} - \frac{( {CTE}_{2} )}{( {CTE}_{1} - {CTE}_{2} )} ,$$

where k is the volume fraction of the first material, CTE₁ is the coefficient of thermal expansion of the first material, and CTE₂ is the coefficient of thermal expansion of the second material. As such, any relationship between aCTE in different regions of the interlayer apply equivalently to the volume fraction of the first material in that region (and thereby to the average cross section of the first material in that region). In particular, in the case where the first material is the low thermal expansion material, the average cross sectional area in each region will decrease with distance from the first surface, and the relationship between differences in average cross sectional area will be the same as the relationships between differences in aCTE as defined above.

Suitable additive manufacturing methods for forming the first structure include powder bed systems, powder feed systems, and wire fed systems.

In a powder bed system, a powder bed is created by raking a powder of the first material across the work area. An energy source (e.g. a laser or electron beam) is used to bind the powder by melting or sintering into the required shape for each layer. A further layer of powder is then raked across the surface, and the process is repeated to build up the structure layer-by-layer.

Alternatively, rather than sintering the powder in-place using an energy source, a binder (e.g. a resin) may be applied to the required areas of powder in each layer, in a technique known as metal binder jetting. This forms a “green” part, which can then be processed into the final structure by curing the binder (if necessary), removing excess powder, and sintering the bound powder. The binder can be chosen such that the step of sintering also removes the binder—i.e. it melts away or burns off, or an additional step to remove the binder e.g. chemically may be included. Further post-processing steps such as infiltration of additional metal into the sintered structure may be included.

As a yet further alternative, the powder may be provided as a mixture of the powder and a curable binder, and the binder may be selectively cured in the required areas in each layer, in a manner equivalent to resin-based 3d printing. This method is known as “metal lithography” or “lithography based metal manufacturing”. Such selective curing may be achieved by selectively exposing a photopolymerisable resin to an appropriate wavelength of light, e.g. using a display screen or laser. Once the “green” structure has been built, it is processed as for the metal binder jetting technique above.

In a powder feed system, a powder of the first material is fed via a nozzle onto the build surface, and heat source (e.g. a laser or electron beam) is used to melt and sinter the powder is as is applied. The nozzle and heat source are then moved relative to the structure (which may involve the nozzle remaining stationary and the structure moving), and the process is repeated to build up the desired structure.

Wire feed systems are similar to powder feed systems, except that the feedstock is a wire of the first material, rather than a powder. The wire is contacted against the workpiece, and the end of the wire is melted (e.g. by a laser or electron beam) to deposit a small dot of the material, and this process is repeated with the wire moved relative to the structure.

Similar systems may provide the first material as a melt spray, or in some other suitable form.

While additive manufacture is the most promising technique for forming the first structure for an interlayer having the desirable mechanical keying and large surface area features discussed earlier, other suitable techniques such as casting may also be used to achieve a first structure such that when the second structure is provided to form the interlayer, the first structure and second structure are shaped such that separating the first and second structure requires deforming one or both of the first or second structure.

The second material may be filled into the first structure by any suitable method. Examples include casting, providing the second material as a powder that is then sintered, providing the second material as a solid which is forced to conform to the first structure via the application of pressure and heat, or providing the second structure in the same additive manufacture process as the first structure.

Casting involves providing the second material as a liquid, which then floods the spaces left by the first structure and is allowed to solidify in place. Casting is appropriate where the melting point of the second material is less than the melting point of the first material, to avoid damage to the first structure during casting.

Where the second material is provided as a powder, this will similarly be made to fill the spaces left by the first structure, and can then be sintered to form the second structure by any suitable technique, e.g. hot isostatic pressing (HIP), cold isostatic pressing, vacuum sintering, uniaxial hot pressing, vacuum uniaxial hot pressing, or field assisted sintering technique (FAST) pressing.

Where the second material is provided as a solid, this may be forced to conform to the second structure by the application of pressure and heat—i.e. causing a plastic deformation of the second material such that it conforms to the first structure and forms the second structure. This is particularly suitable where the second material is more deformable than the first material, such that the second material is deforming around a substantially unchanged first structure.

With any of the above techniques, bonding may be improved by first providing a thin layer of the second material on the upper face of the first structure, e.g. by the application of a foil, by plasma spraying, by chemical vapour deposition, or other suitable technique.

The second structure may also be provided within the same additive manufacturing technique as the first structure. For powder bed techniques, this may be performed by providing each powder layer such that certain regions of the layer comprise a powder of the first material, and other regions of the layer comprise a powder of the second material, such that the first and second structures are formed together when the powder layers are bound (whether by melting, sintering, or application of a binder). For powder and wire fed techniques, this may be done by providing separate feeds for each of the first and second material, or a single feed which can switch between the two materials during the additive manufacturing process.

Additionally, with any of the above techniques, they may be performed in a way which forms the component the interlayer is joined to in situ on the interlayer, or vice versa. For example, when the second material is cast or provided as a powder, this may be done in a mould such that the portions beyond the interlayer form the desired component. Where the second material is provided as a solid and forced to conform by pressure, this solid may be the component which the interlayer is intended for. Where the second material is constructed via additive manufacture, the additive manufacture may also form the desired component.

One particular example use case for such interlayers is in attaching cooling apparatus, e.g. heat sinks and heat exchangers, to components expected to undergo high heat flux. In such examples the interlayer typically connects a high thermal expansion material (e.g. copper) of the cooling apparatus to a low thermal expansion material (e.g. tungsten or other refractory metal) of the component undergoing high heat flux. A particular example of such a component is a divertor of a tokamak plasma chamber, as described in the background.

Example materials for the interlayer include the case where the first and second material are both metals, e.g. the first material is a refractory metal or an alloy thereof, and the second material is copper or an alloy thereof. The refractory metals are those elemental metals having a melting point above 1850° C., which includes niobium, molybdenum, tantalum, tungsten, rhenium, and titanium.

1. A method of manufacturing an interlayer comprising a first material and a second material, the method comprising:
providing a first surface;
forming a first structure from the first material on the first surface using an additive manufacturing technique, wherein the first structure comprises at least one surface which is not in contact with the first surface and faces towards the first surface at an angle of less than 90 degrees;
following formation of the first structure, forming a second structure from the second material, such that the second structure conforms to the first structure on a side of the first structure opposite the first surface and extends to a second surface;
wherein the first structure and the second structure together form the interlayer, and the first structure and second structure are shaped such that separating the first and second structure requires deforming one or both of the first or second structure.

2. A method according to claim 1, wherein the additive manufacturing technique is a powder bed technique, and comprises:
providing a layer of powder of the first material on the first surface;
bonding a portion of the layer of powder to form a part of the first structure;
providing a further layer of powder on top of the sintered powder;
repeating the steps of bonding and providing further layers of powder to form the first structure.

3. A method according to claim 2, wherein the step of bonding the portion of the layer of powder comprises melting or sintering the portion of the layer of powder by providing heat to the powder using a laser or electron beam.

4. A method according to claim 2, wherein the step of bonding the portion of the layer of powder comprises one of:
applying a binder to the portion of the layer of powder or
selectively curing a binder, where the binder is present in the portion of the layer of powder prior to the step of bonding, and
wherein the additive manufacturing technique further comprises sintering the portions of the layers of powder to form the first structure after completion of all steps of binding and providing further layers.

5. A method according to claim 1, wherein the first material has a higher melting point than the second material, and wherein the step of forming the second structure comprises providing the second material as a liquid, flowing the second material onto the first structure, and allowing the second material to solidify.

6. A method according to claim 1, wherein the step of forming the second structure comprises providing the second material as a powder, packing the powder on the side of the first structure opposite the first surface, and sintering the powder.

7. A method according to claim 1, wherein the step of forming the second structure comprises providing the second material as a solid, and pressing the second material against the side of the first structure opposite the first surface with sufficient pressure that the second material conforms to the shape of the side of the first structure opposite the first surface.

8. A method according to claim 1, wherein the step of forming the second layer comprises applying a layer of the second material to the side of the first structure opposite the first surface prior to forming the rest of the second structure.

9. A method according to claim 8, wherein the layer of the second material is applied by one of:
application of a foil of the second material to the surface;
physical vapour deposition; or
chemical vapour deposition.

10. A method according to claim 1, wherein the first structure is a periodic structure which repeats in at least one direction parallel to the first surface.

11. A method according to claim 1, wherein the first structure has a cross section parallel to the first surface which varies such that the cross section of the first structure decreases monotonically through the thickness of the interlayer from the first surface.

12. A method according to claim 11, wherein the function relating the cross section of the first structure to the depth through the interlayer is one of:
a linear function;
a sigmoid function;
a polynomial function; or
a cubic function.

13. A method according to claim 11, wherein the first structure has first, second, third, and fourth average coefficients of thermal expansion, aCTE, defined such that each aCTE is the average coefficient of thermal expansion of the first and second material, weighted by their volume fraction, over one quarter of the thickness of the interlayer; and wherein
the first aCTE is defined from the surface of the interlayer opposite the first surface;
the second aCTE is defined from the midpoint of the thickness of the interlayer towards the surface of the interlayer opposite the first surface and is less than the first aCTE;
the third aCTE is defined from the midpoint of the interlayer towards the first surface and is less than the second aCTE;
the fourth aCTE is defined from the first surface and is less than the third aCTE; wherein either:
the difference between the first and second aCTE is greater than the difference between the second and third aCTE, and the difference between the second and third aCTE is greater than the difference between the third and fourth aCTE; or
the difference between the second and third aCTE is greater than both the difference between the first and second aCTE and the difference between the third and fourth aCTE;
wherein each aCTE is related to the volume fraction of the first structure within the interlayer by the equation
$$k = \frac{aCTE}{( {CTE}_{1} - {CTE}_{2} )} - \frac{( {CTE}_{2} )}{( {CTE}_{1} - {CTE}_{2} )} ,$$
where k is the volume fraction of the first structure within the interlayer, CTE₁ is the coefficient of thermal expansion of the first material, and CTE₂ is the coefficient of thermal expansion of the second material.

14. A method according to claim 1, wherein the first structure has a shape which is one of:
the locus of points enclosed by a triply periodic minimal surface within the bounds of the interlayer;
the locus of points within a fixed distance of a triply periodic minimal surface within the bounds of the interlayer; or
the locus of points within a variable distance of a triply periodic minimal surface within the bounds of the interlayer, wherein the variable distance is defined by a function which depends on the position within the interlayer.

15. An interlayer for joining first and second components, the interlayer comprising:
first and second surfaces;
a first structure formed from a first material, and extending from the first surface, wherein the first structure has at least one surface which is not in contact with the first surface and faces towards the first surface at an angle of less than 90 degrees;
a second structure formed from a second material, wherein the second structure extends to the second surface and conforms to the first structure on a side of the first structure opposite the first surface;
wherein the first structure and the second structure together form the interlayer, and the first structure and second structure are shaped such that separating the first and second structure requires deforming one or both of the first or second structure;
wherein the interlayer is formed by the method of claim 1.

16. An interlayer according to claim 15, wherein the first structure is a periodic structure which repeats in at least one direction parallel to the first surface.

17. An interlayer according to claim 15, wherein the first structure has a cross section parallel to the first surface which varies such that the cross section of the first structure decreases monotonically through the thickness of the interlayer from the first surface.

18. An interlayer according to claim 17, wherein the function relating the cross section of the first structure to the depth through the interlayer is one of:
a linear function;
a sigmoid function;
a polynomial function; or
a cubic function.

19. An interlayer according to claim 17, wherein the first structure has first, second, third, and fourth average coefficients of thermal expansion, aCTE, defined such that each aCTE is the average coefficient of thermal expansion of the first and second material, weighted by their volume fraction, over one quarter of the thickness of the interlayer; and wherein
the first aCTE is defined from the surface of the interlayer opposite the first surface;
the second aCTE is defined from the midpoint of the thickness of the interlayer towards the surface of the interlayer opposite the first surface and is less than the first aCTE;
the third aCTE is defined from the midpoint of the interlayer towards the first surface and is less than the second aCTE;
the fourth aCTE is defined from the first surface and is less than the third aCTE; wherein either:
the difference between the first and second aCTE is greater than the difference between the second and third aCTE, and the difference between the second and third aCTE is greater than the difference between the third and fourth aCTE; or
the difference between the second and third aCTE is greater than both the difference between the first and second aCTE and the difference between the third and fourth aCTE;
wherein each aCTE is related to the volume fraction of the first structure within the interlayer by the equation
$$k = \frac{aCTE}{( {CTE}_{1} - {CTE}_{2} )} - \frac{( {CTE}_{2} )}{( {CTE}_{1} - {CTE}_{2} )} ,$$
where k is the volume fraction of the first structure within the interlayer, CTE₁ is the coefficient of thermal expansion of the first material, and CTE₂ is the coefficient of thermal expansion of the second material.

20. An interlayer according to claim 15, wherein the first structure has a shape which is one of:
the locus of points enclosed by a triply periodic minimal surface within the bounds of the interlayer;
the locus of points within a fixed distance of a triply periodic minimal surface within the bounds of the interlayer; or
the locus of points within a variable distance of a triply periodic minimal surface within the bounds of the interlayer, wherein the variable distance is defined by a function which depends on the position within the interlayer.
